(19) United States
(12) Patent Application Publication
(10) Pub. No.: US 2023/0297863 A1
(43) Pub. Date: Sep. 21, 2023

(54) MACHINE LEARNING PIPELINE GENERATION AND MANAGEMENT

(71) Applicant: C3.ai, Inc., Redwood City, CA (US)

(72) Inventors: Phoebus Chen, Mountain View, CA (US); Dennis Wang, Redwood City, CA (US); Harald Weppner, Redwood City, CA (US); Aliakbar Panahi, Redwood City, CA (US); Saumya Saran, Menlo Park, CA (US); Kleoni Ioannidou, Sunnyvale, CA (US); Louis Poirier, Paris (FR)

(21) Appl. No.: 18/185,186

(22) Filed: Mar. 16, 2023

Related U.S. Application Data
(60) Provisional application No. 63/269,605, filed on Mar. 18, 2022.

(51) Int. Cl. G06N 7/01

(52) U.S. Cl. CPC G06N 7/01

(57) ABSTRACT

A method includes generating an authoring representation of a machine learning pipeline based on a received input, where the authoring representation is configured to manage one or more machine learning operations. The method also includes receiving an indication of an operation to be performed on the authoring representation. The method further includes translating the authoring representation to an intermediate representation based on the operation and optimizing the intermediate representation. In addition, the method includes translating the intermediate representation to an execution representation that is understood by one or more machine learning executors.

### CROSS-REFERENCE TO RELATED APPLICATION AND PRIORITY CLAIM

This application claims priority under 35 U.S.C. § 119(e) to U.S. Provisional Patent Application No. 63/269,605 filed on Mar. 18, 2022. This provisional application is hereby incorporated by reference in its entirety.

### TECHNICAL FIELD

This disclosure is generally directed to machine learning systems. More specifically, this disclosure is directed to a system and method for machine learning pipeline generation and management.

### BACKGROUND

A machine learning pipeline is a software system that provides a way to compose and execute multiple data processing and machine learning steps in an ordered sequence. Each step may take in one or more data inputs and return one or more data outputs. A machine learning pipeline is often constructed to perform one or more machine learning operations. Typical operations of the pipeline can include training one or more machine learning steps, automatically tuning training parameters of the machine learning steps (such as during hyperparameter optimization), predicting new data given a pipeline containing one or more trained machine learning steps, measuring (scoring) the performance of the prediction results, or interpreting the contribution level of different input data to the prediction results. The base machine learning pipeline functionality may be extended to include additional operations or to change the logic of existing operations.

### SUMMARY

This disclosure relates to a system and method for machine learning pipeline generation and management.

In a first embodiment, a method includes generating an authoring representation of a machine learning pipeline based on a received input, where the authoring representation is configured to manage one or more machine learning operations. The method also includes receiving an indication of an operation to be performed on the authoring representation. The method further includes translating the authoring representation to an intermediate representation based on the operation and optimizing the intermediate representation. In addition, the method includes translating the intermediate representation to an execution representation that is understood by one or more machine learning executors.

In a second embodiment, an apparatus includes at least one processing device configured to generate an authoring representation of a machine learning pipeline based on a received input, where the authoring representation is configured to manage one or more machine learning operations. The at least one processing device is also configured to receive an indication of an operation to be performed on the authoring representation. The at least one processing device is further configured to translate the authoring representation to an intermediate representation based on the operation and optimize the intermediate representation. In addition, the at least one processing device is configured to translate the intermediate representation to an execution representation that is understood by one or more machine learning executors.

In a third embodiment, a non-transitory computer readable medium stores computer readable program code that, when executed by one or more processors, causes the one or more processors to generate an authoring representation of a machine learning pipeline based on a received input, where the authoring representation is configured to manage one or more machine learning operations. The non-transitory computer readable medium also stores computer readable program code that, when executed by the one or more processors, causes the one or more processors to receive an indication of an operation to be performed on the authoring representation. The non-transitory computer readable medium further stores computer readable program code that, when executed by the one or more processors, causes the one or more processors to translate the authoring representation to an intermediate representation based on the operation and optimize the intermediate representation. In addition, the non-transitory computer readable medium stores computer readable program code that, when executed by the one or more processors, causes the one or more processors to translate the intermediate representation to an execution representation that is understood by one or more machine learning executors.

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIG. 1 illustrates an example system supporting machine learning pipeline generation and management according to this disclosure:

FIG. 2 illustrates an example device supporting machine learning pipeline generation and management according to this disclosure;

FIG. 3 illustrates an example architecture for machine learning pipeline generation and management according to this disclosure;

FIGS. 4A through 4D illustrate examples of optimizations that can be performed in an optimization layer in the architecture of FIG. 3 according to this disclosure;

FIG. 5 illustrates an example of machine learning pipeline composability using the architecture of FIG. 3 according to this disclosure:

FIG. 6 illustrates an example directed acyclic graph (DAG) machine learning pipeline that can be authored using the architecture shown in FIG. 3 according to this disclosure; and

FIG. 7 illustrates an example method for machine learning pipeline generation and management according to this disclosure.

### DETAILED DESCRIPTION

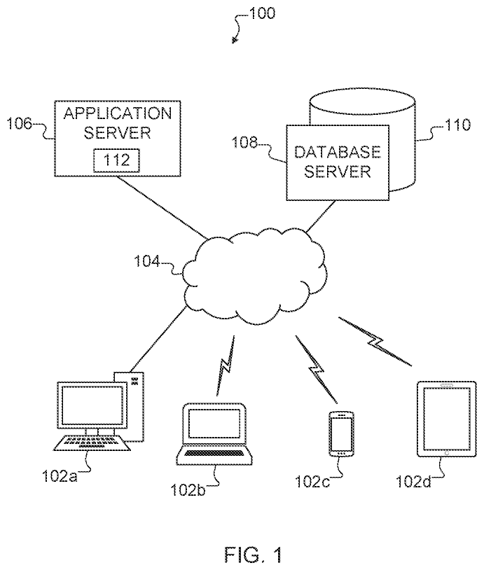

FIGS. 1 through 7, described below, and the various embodiments used to describe the principles of the present invention in this patent document are by way of illustration only and should not be construed in any way to limit the scope of the invention. Those skilled in the art will understand that the principles of the present invention may be implemented in any type of suitably arranged device or system.

As noted above, a machine learning pipeline is a software system that provides a way to compose and execute multiple data processing and machine learning steps in an ordered sequence. Each step may take in one or more data inputs and return one or more data outputs. A machine learning pipeline is often constructed to perform one or more machine learning operations. Typical operations of the pipeline can include training one or more machine learning steps, automatically tuning training parameters of the machine learning steps (such as during hyperparameter optimization), predicting new data given a pipeline containing one or more trained machine learning steps, measuring (scoring) the performance of the prediction results, or interpreting the contribution level of different input data to the prediction results. The base machine learning pipeline functionality may be extended to include additional operations or to change the logic of existing operations.

In some systems, a machine learning pipeline's “authored representation” represents the sequence of steps constructed by a user and defines the pipeline, where the authored representation is specific to one or more machine learning operations. For example, a machine learning pipeline using some systems may require a training step that is independent of a prediction step. In addition, some systems do not include a directed acyclic graph (DAG) topology for authoring or execution graphs.

This disclosure provides an apparatus, method, and computer readable medium supporting a process for machine learning pipeline generation and management. The disclosed embodiments allow multiple operations to be performed on a single pipeline representation. This allows for a single user-defined representation (the “authoring representation”) of a machine learning pipeline, so the user does not have to maintain separate pipelines for each operation. Stated differently, a user (such as a data scientist) can author a machine learning pipeline only once, unifying training, prediction, scoring, tuning, and interpreting operations without having to repeat any of the operations. Here, the authoring representation can manage each operation described without requiring operation-specific steps or different user-defined pipeline architectures corresponding to each operation.

The disclosed authoring representation allows for static typing of the inputs and outputs of each step, which can be used for validating that the steps are connected properly. The authoring representation also allows for clearly defining the input/output signatures of the machine learning operations in the pipeline, thus creating a well-defined interface for connecting to an external software system. In addition, the disclosed authoring representation supports a directed acyclic graph (DAG) topology as described in greater detail below.

FIG. 1 illustrates an example system 100 supporting machine learning pipeline generation and management according to this disclosure. For example, the system 100 shown here can be used to support a three-layer machine learning pipeline architecture described below. As shown in FIG. 1, the system 100 includes user devices 102a-102d, one or more networks 104, one or more application servers 106, and one or more database servers 108 associated with one or more databases 110. Each user device 102a-102d communicates over the network 104, such as via a wired or wireless connection. Each user device 102a-102d represents any suitable device or system used by at least one user to provide or receive information, such as a desktop computer, a laptop computer, a smartphone, and a tablet computer. However, any other or additional types of user devices may be used in the system 100.

The network 104 facilitates communication between various components of the system 100. For example, the network 104 may communicate Internet Protocol (IP) packets, frame relay frames, Asynchronous Transfer Mode (ATM) cells, or other suitable information between network addresses. The network 104 may include one or more local area networks (LANs), metropolitan area networks (MANs), wide area networks (WANs), all or a portion of a global network such as the Internet, or any other communication system or systems at one or more locations.

The application server 106 is coupled to the network 104 and is coupled to or otherwise communicates with the database server 108. In some embodiments, the application server 106 supports the three-layer machine learning pipeline architecture described below. For example, the application server 106 may execute one or more applications 112 that use data from the database 110 to perform operations associated with machine learning pipeline generation and management. Note that the database server 108 may also be used within the application server 106 to store information, in which case the application server 106 may store the information itself used to perform operations associated with machine learning pipeline generation and management.

The database server 108 operates to store and facilitate retrieval of various information used, generated, or collected by the application server 106 and the user devices 102a-102d in the database 110. For example, the database server 108 may store various information related to machine learning pipeline generation and management.

Although FIG. 1 illustrates one example of a system 100 supporting machine learning generation and management, various changes may be made to FIG. 1. For example, the system 100 may include any number of user devices 102a-102d, networks 104, application servers 106, database servers 108, and databases 110. Also, these components may be located in any suitable location(s) and might be distributed over a large area. In addition, while FIG. 1 illustrates one example operational environment in which a machine learning pipeline may be used, this functionality may be used in any other suitable system.

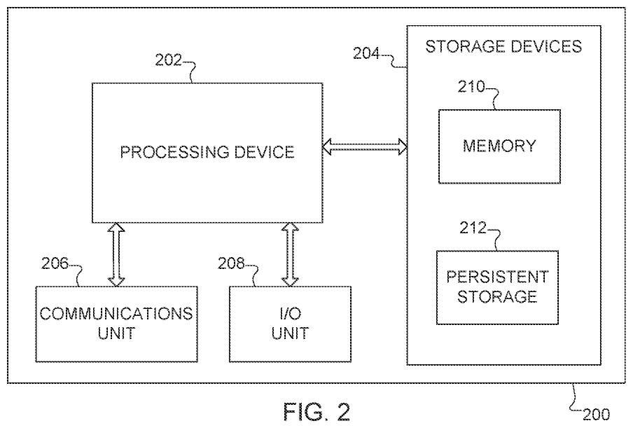

FIG. 2 illustrates an example device 200 supporting machine learning pipeline generation and management according to this disclosure. One or more instances of the device 200 may, for example, be used to at least partially implement the functionality of the application server 106 of FIG. 1. However, the functionality of the application server 106 may be implemented in any other suitable manner. In some embodiments, the device 200 shown in FIG. 2 may form at least part of a user device 102a-102d, application server 106, or the database server 108 in FIG. 1. However, each of these components may be implemented in any other suitable manner.

As shown in FIG. 2, the device 200 denotes a computing device or system that includes at least one processing device 202, at least one storage device 204, at least one communications unit 206, and at least one input/output (I/O) unit 208. The processing device 202 may execute instructions that can be loaded into a memory 210. The processing device 202 includes any suitable number(s) and type(s) of processors or other processing devices in any suitable arrangement. Example types of processing devices 202 include one or more microprocessors, microcontrollers, reduced instruction set computers (RISCs), complex instruction set computers (CISCs), graphics processing units (GPUs), data processing units (DPUs), virtual processing units, associative process units (APUs), tensor processing units (TPUs), vision processing units (VPUs), neuromorphic chips, AI chips, quantum processing units (QPUs), cerebras wafer-scale engines (WSEs), digital signal processors (DSPs), ASICs, field programmable gate arrays (FPGAs), or discrete circuitry.

The memory 210 and a persistent storage 212 are examples of storage devices 204, which represent any structure(s) capable of storing and facilitating retrieval of information (such as data, program code, and/or other suitable information on a temporary or permanent basis). The memory 210 may represent a random access memory or any other suitable volatile or non-volatile storage device(s). The persistent storage 212 may contain one or more components or devices supporting longer-term storage of data, such as a read only memory, hard drive, Flash memory, or optical disc.

The communications unit 206 supports communications with other systems or devices. For example, the communications unit 206 can include a network interface card or a wireless transceiver facilitating communications over a wired or wireless network, such as the network 104. The communications unit 206 may support communications through any suitable physical or wireless communication link(s).

The I/O unit 208 allows for input and output of data. For example, the I/O unit 208 may provide a connection for user input through a keyboard, mouse, keypad, touchscreen, or other suitable input device. The I/O unit 208 may also send output to a display, printer, or other suitable output device. Note, however, that the I/O unit 208 may be omitted if the device 200 does not require local 110, such as when the device 200 represents a server or other device that can be accessed remotely.

Although FIG. 2 illustrates one example of a device 200 supporting machine learning pipeline generation and management, various changes may be made to FIG. 2. For example, computing and communication devices and systems come in a wide variety of configurations, and FIG. 2 does not limit this disclosure to any particular computing or communication device or system.

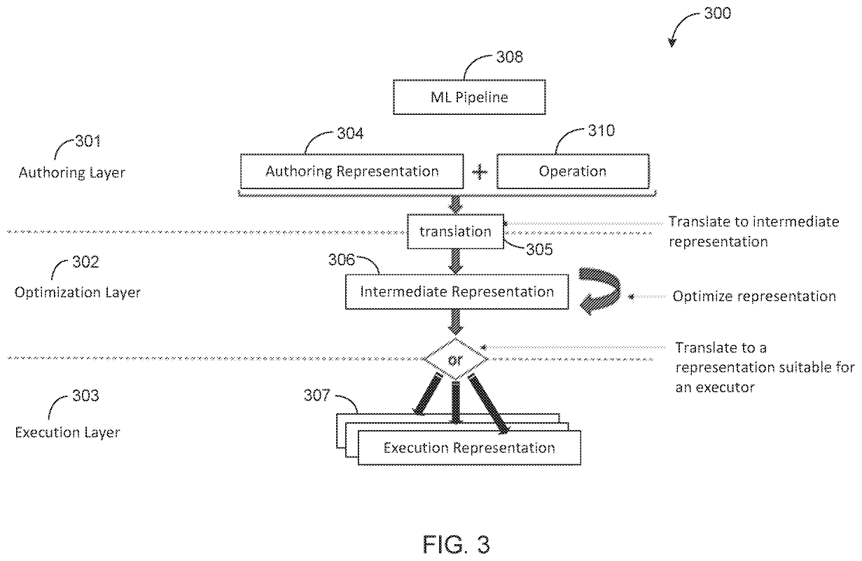

FIG. 3 illustrates an example architecture 300 for machine learning pipeline generation and management according to this disclosure. In some cases, the architecture 300 may be implemented in a machine learning pipeline system, which can be executed using one or more devices, such as the application server 106 or one of the user devices 102a-102d of FIG. 1. As shown in FIG. 3, the architecture 300 is a three-layered architecture that enables a user (such as a data scientist, a machine learning pipeline author, or the like) to declare what needs to be computed while leaving the system to decide how to execute the computation.

In this example, the three layers include an authoring layer 301, an optimization layer 302, and an execution layer 303. The user interacts only with the “top” layer of the architecture 300, namely the authoring layer 301. The user generally uses the authoring layer 301 to define an authoring representation 304 of a machine learning pipeline 308. In the architecture 300, the authoring representation 304 manages various operations 310 of the machine learning pipeline 308 without requiring machine learning operation-specific steps or different user-defined pipeline architectures corresponding to each operation 310. That is, the authoring representation 304 does not require a user to write, e.g., an explicit training step and then a prediction step when authoring the machine learning pipeline 308. For example, consider the user constructing a simple machine learning pipeline 308 in the authoring layer 301:

pipelineX=stepA->stepB->stepC.

Note that this machine learning pipeline 308 has no machine learning operation-specific steps like “train” or “predict” specified in the authoring layer 301. Instead, such steps are implicit in the construction of the machine learning pipeline 308. When an ML operation is executed on pipelineX, such as pipelineX.train( ) (which represents pipeline X+the operation “train”), the following steps are automatically executed without user definition: stepA.train( ) to train stepA's model, stepA.process( ) to produce inputs for step B, stepB.train( ) to train stepB's model, stepB.process( ) to produce inputs for stepC, stepC.train( ) to train stepC's model, and then packaging of all the trained steps.

When the user specifies an operation 310 to be performed on the authoring representation 304, the authoring representation 304 is translated to an intermediate representation 306 via a translation operation 305. The operation 310 to be performed, as specified by the user, can include training one or more machine learning operations, tuning one or more training parameters of the one or more machine learning operations, predicting new data, scoring the performance of a prediction result, interpreting a contribution level of different input data to prediction results, or the like. Herein, scoring the performance of the prediction result refers to measuring the quality of the predictions output by the model. For example, one scoring metric for machine learning models is accuracy, in which, given the predictions and the ground truth values, a real number (the score) is determined that indicates how well the predictions match the ground truth. Other example scoring metrics for machine learning models include precision, recall, and mean absolute error. The architecture 300 enables the user to author and train a machine learning model once (such as by using a large dataset), and the machine learning model can be executed many times using smaller inputs.

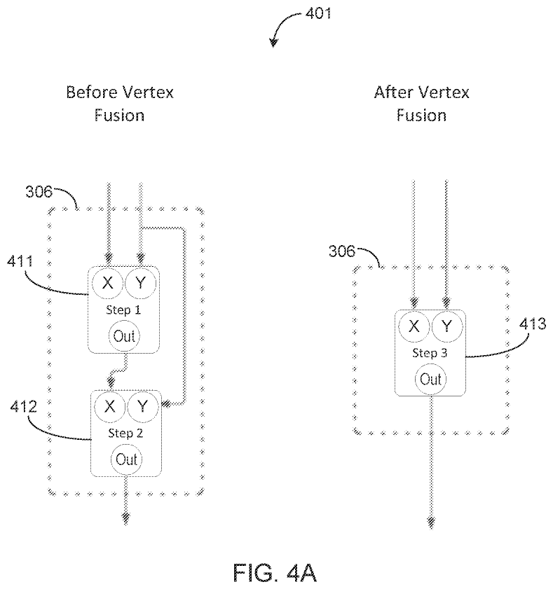

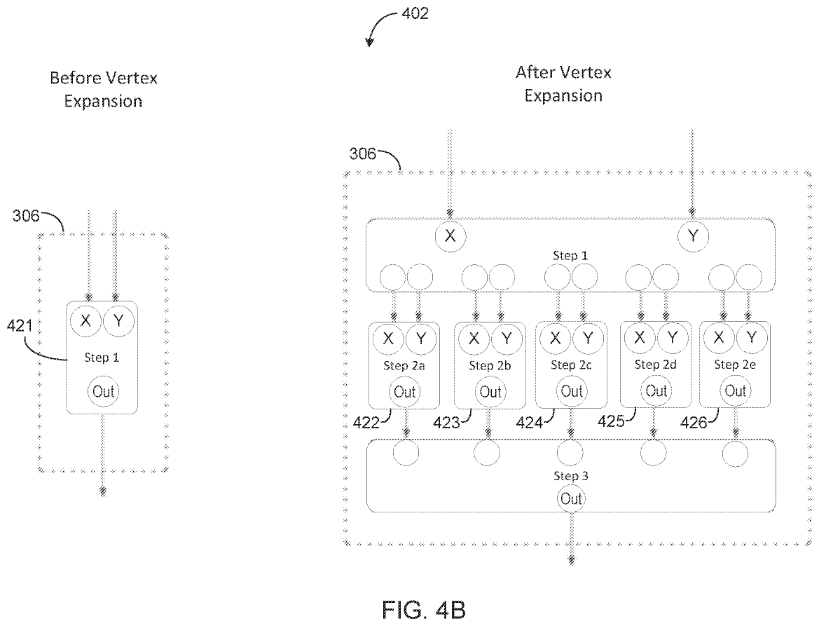

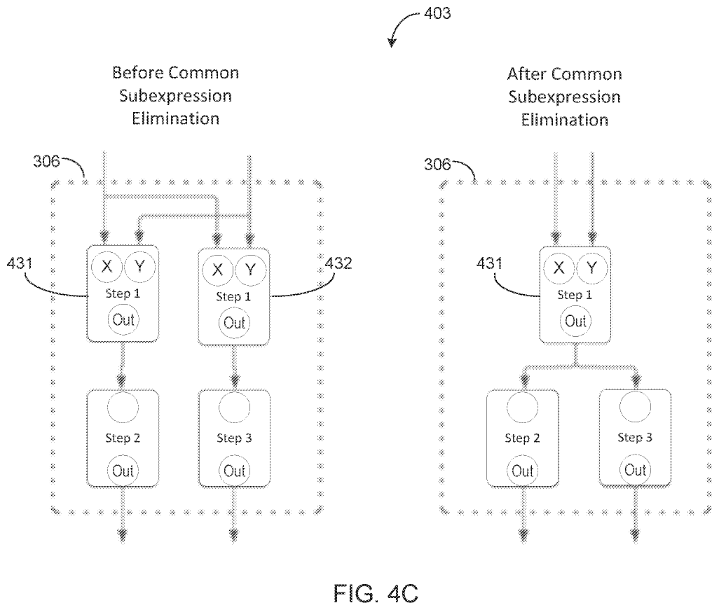

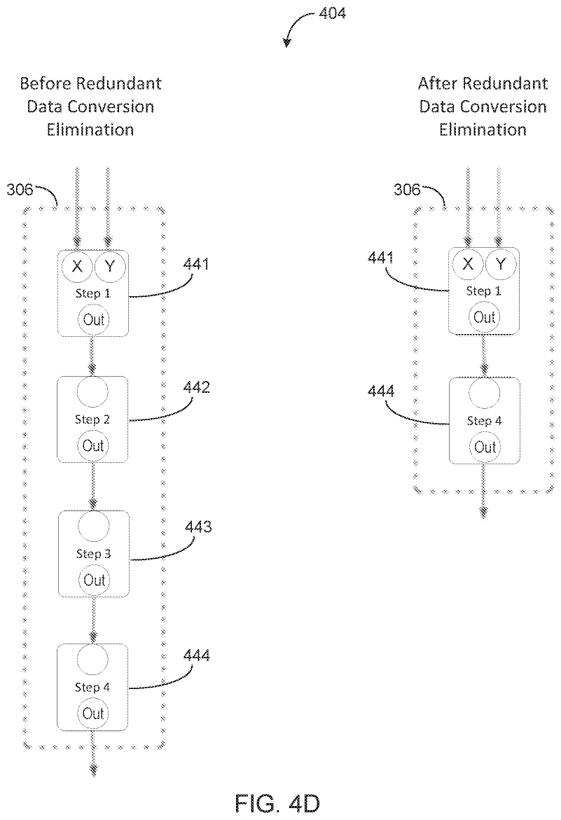

The intermediate representation 306 can be optimized by the system using the optimization layer 302, resulting in another intermediate representation 306 that can produce the same results. In the optimization laver 302, the system automatically optimizes the execution of the machine learning pipeline 308 based on various criteria, such as for cost or latency, depending on the inputs provided and the outputs requested. In some embodiments, various optimizations could be applied when transforming an authored machine learning pipeline 308 into an executable representation. For example, FIGS. 4A through 4D illustrate examples of optimizations 401-404 that can be performed in an optimization layer 302 in the architecture 300 of FIG. 3 according to this disclosure.

FIG. 4A illustrates an example of vertex fusion 401. As shown in FIG. 4A, the intermediate representation 306 includes two vertices 411 and 412 having compatible execution environments. The vertex fusion 401 combines the two vertices 411 and 412 into a single vertex 413. This can improve performance, such as by minimizing the overhead of marshalling and unmarshalling and by minimizing the passing of data between steps. While the vertex fusion 401 is shown in FIG. 4A as combining two vertices into one vertex, this is merely one example, and other numbers of vertices could be fused into other smaller numbers of vertices.

FIG. 4B illustrates an example of vertex expansion 402. As shown in FIG. 4B, the intermediate representation 306 includes the vertex 421. The vertex expansion 402 divides or partitions the single vertex 421 into multiple vertices 422-426. Expanding a vertex can advantageously enable concurrent execution of different portions of the vertex in a distributed system, such as by partitioning input data into separate batches for prediction. While the vertex expansion 402 is shown in FIG. 4B as dividing one vertex into five vertices, this is merely one example, and other numbers of vertices could be divided into other larger numbers of vertices.

FIG. 4C illustrates an example of common subexpression elimination 403. As shown in FIG. 4C, the intermediate representation 306 includes sub-graphs 431 and 432, which in this case are repetitive or redundant of one another. The common subexpression elimination 403 identifies the repetitive or redundant sub-graphs 431 and 432 and eliminates one of the sub-graphs 432, leaving only the sub-graph 431. The transformed intermediate representation 306 remains directed and acyclic. While the common subexpression elimination 403 is shown in FIG. 4C as eliminating one of two repetitive or redundant sub-graphs, this is merely one example, and other numbers of sub-graphs or other subexpressions could be eliminated.

FIG. 4D illustrates an example of redundant data conversion elimination 404. Redundant data conversion elimination refers to automatically avoiding compute-intensive data transformations. In the example shown in FIG. 4D, the intermediate representation 306 includes four steps 441-444. Step 443 (“step 3”) is the inverse of step 442 (“step 2”), which means that the output of step 443 is the same as the input to step 442. The redundant data conversion elimination 404 eliminates steps 442 and 443 altogether, leaving only steps 441 and 444. This can improve performance, such as by minimizing the overhead of passing data between steps. While the redundant data conversion elimination 404 is shown in FIG. 4D as eliminating two steps, this is merely one example, and other numbers of steps could be eliminated.

Although FIGS. 4A through 4D illustrate various examples of optimizations 401-404 that can be performed in the optimization layer 302, various changes may be made to FIGS. 4A through 4D. For example, other or additional types of optimizations can be performed in the optimization layer 302. Also, note that all optimizations preserve semantics with the authored machine learning pipeline 308 and are applied using a strategy that defines both the sequence of optimizations and the number of times an optimization occurs.

Returning to FIG. 3, once the one or more optimizations have been performed on the intermediate representation 306, the system translates the intermediate representation 306 into an execution representation 307 that is understood by an underlying executor, which will decide how to execute the execution representation 307 to return desired results. There can be multiple options for executing an execution representation 307 of a machine learning pipeline 308, such as running on an executor most suitable for training on large-scale data, point inferencing with low-latency demands, or other options.

The architecture 300 supports heterogeneous execution environments for different steps or operations in the machine learning pipeline 308. Among other things, this can allow for user flexibility of using open-source languages, frameworks, and libraries. That is, the architecture 300 is not limited to any specific system, development application, or production application. Also, each machine learning pipeline 308 can be exported or imported between different applications as needed or desired.

In addition, differentiation of machine learning pipelines 308 in the architecture 300 allows the user to remove one or more operations 310 of the machine learning pipeline 308 or replace one or more operations 310 with one or more different operations 310. This differentiation also allows different operations 310 to be performed using different hardware, such as to support different resource requirements. Most machine learning pipelines execute on one type of hardware. In contrast, the architecture 300 allows the user to divide the execution representation 307 of the machine learning pipeline 308 into multiple parts so that different operations 310 or different steps of one operation 310 can be executed on different (potentially more suitable or advantageous) hardware. For example, assume step A is a pre-processing routine, step B is a deep learning model, and step C is a post-processing routine. The architecture 300 allows step A and step C to execute on commodity hardware, while step B can leverage accelerated hardware, such as a GPU. In some embodiments, a user can provide hints, parameters, or instructions to the system to help the system determine on which hardware an operation should be executed.

To prevent unwanted or unsuitable changes to the machine learning pipeline 308, the architecture 300 allows freezing of part or all of the machine learning pipeline 308. As used here, “freezing” a machine learning pipeline refers to the system's ability to enforce immutability after a specific user action occurs. One example is freezing a machine learning pipeline after training the machine learning model. Since machine learning pipelines are composable, the freezing may affect only one or more parts of an entire machine learning pipeline without affecting one or more other parts of the machine learning pipeline.

In some embodiments, the architecture 300 enables the system to learn the minimum resources (such as memory, CPUs, GPUs, and the like) required to execute an operation 310 in the machine learning pipeline 308. Once the required resources are learned, the system can restrict certain operations 310 (such as predicting and interpreting) so that execution on resource-constrained devices is possible.

In the architecture 300, each operation 310 in the machine learning pipeline 308 may be implemented in a unique language with a language version, use unique frameworks and libraries, and run on a unique executor. Some examples of languages that can be used include JAVA, JAVASCRIPT, PYTHON, and the like. Some examples of frameworks and libraries that can be used include TENSORFLOW, KERAS, SCIKIT-LEARN, PYTORCH, SPACY, HUGGINGFACE, XGBOOST, and the like. Some examples of executors that can be used include SPARK, RAY, APACHE AIRFLOW. ARGO WORKFLOWS, and the like. Of course, other languages, frameworks, libraries, and executors are possible, and these examples do not limit the scope of the disclosure.

The architecture 300 facilitates pipeline composability by allowing the user to compose the machine learning pipeline 308 from existing, independently authored machine learning pipelines while the system maintains all claimed properties. Moreover, optimizations can be performed on the composition of multiple machine learning pipelines 308. In some embodiments, multiple machine learning pipelines 308 can be executed as a single execution graph even when the machine learning pipelines 308 have no knowledge of each other. In addition, machine learning pipelines 308 can be nested without difficulty. For example, a machine learning pipeline 308 developed by user A can be re-used in a larger machine learning pipeline 308 by user B. User A's machine learning pipeline 308 can be trained and made untrainable for future users (such as via freezing), which may allow the sharing of interesting functionalities without confidentiality or intellectual property breaches or performance degradation from user B. As a particular example, assume user A develops a computer vision pipeline, and user B wants to use the computer vision pipeline for a default detection application in manufacturing. The architecture 300 allows user B to use user A's pipeline and add pre-processing and post-processing steps for user B's specific application. Similarly, a machine learning pipeline 308 developed for a given task by user A might be shared without obfuscation. User B can decide to re-use user A's machine learning pipeline 308 but replace one or multiple steps with user B's own implementation. This would allow user B to use his or her own expertise in a specific area while leveraging the previous work of preprocessing, post-processing, and any parallel tasks built by user A.

Once the machine learning pipeline 308 is composed, the architecture 300 supports full pipeline persistence, including the ability of a user to name, save, and retrieve the machine learning pipeline 308. This in turn enables proper deployment of the machine learning pipeline 308. In addition, the architecture 300 allows for rich query filters to retrieve the machine learning pipeline 308 because the architecture 300 handles the machine learning models as reusable objects. Also, once the machine learning pipeline 308 is composed, the architecture 300 also allows for inspection of the machine learning pipeline 308. Pipeline inspection allows the user to trace execution paths back to the authoring level in order to understand how the machine learning pipeline 308 was originally authored. For instance, a user can inspect the performance of the machine learning pipeline 308, determine how long prediction or training took, and the like.

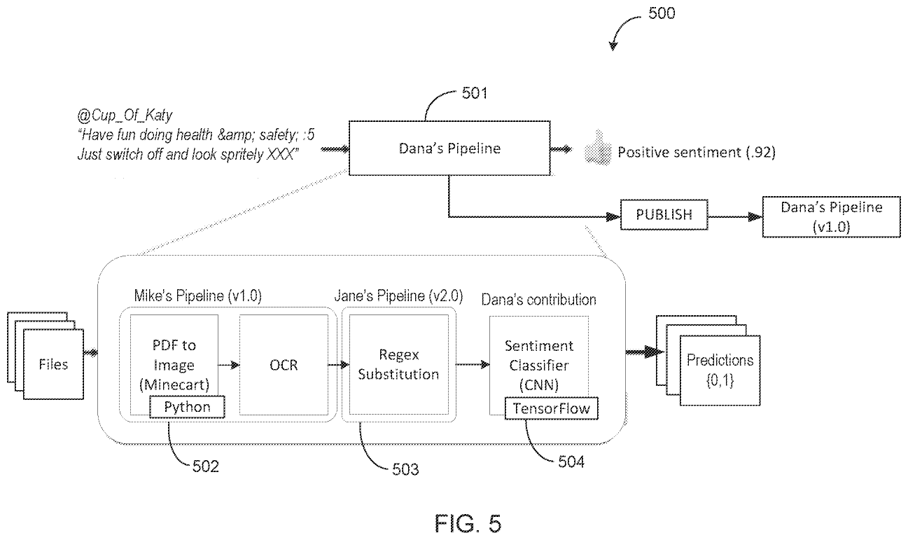

FIG. 5 illustrates a specific example 500 of machine learning pipeline composability using the architecture 300 according to this disclosure. As shown in FIG. 5, the example 500 involves multiple machine learning pipelines 501-503, each of which can represent (or be represented by) the machine learning pipeline 308 of FIG. 3. The machine learning pipeline 501 (“Dana's Pipeline”) is composed of elements from the previously-generated machine learning pipeline 502 (“Mike's Pipeline (v1.0)”) and the previously-generated machine learning pipeline 503 (“Jane's Pipeline (v2.0)”). To compose the machine learning pipeline 501, Dana adds a sentiment classifier 504 to the machine learning pipelines 501-502 before publishing. Note that machine learning pipelines composed in one language or using one framework can later be re-used in a machine learning pipeline composed in another language or using another framework. For example, the previously-generated machine learning pipeline 502 may be composed using various PYTHON libraries like MINECART and TESSERACT, while the sentiment classifier 504 may be composed using the TENSORFLOW framework.

Although FIG. 5 illustrates one example 500 of machine learning pipeline composability using the architecture 300, various changes may be made to FIG. 5. For example, the languages and frameworks shown in FIG. 5 are merely examples, and other languages and/or frameworks could be additionally or alternatively used.

The architecture 300 enables composition of multiple steps into a directed acyclic graph (DAG) machine learning pipeline and allows nesting of multiple machine learning pipelines inside higher level machine learning pipelines. A DAG machine learning pipeline can have one or multiple source nodes (multiple inputs) and one or multiple sink nodes (multiple outputs). This may be useful or important for many machine learning applications, such as when the user wants to combine the outputs of multiple models applied on multiple sources of data in order to compute one or a few final scores.

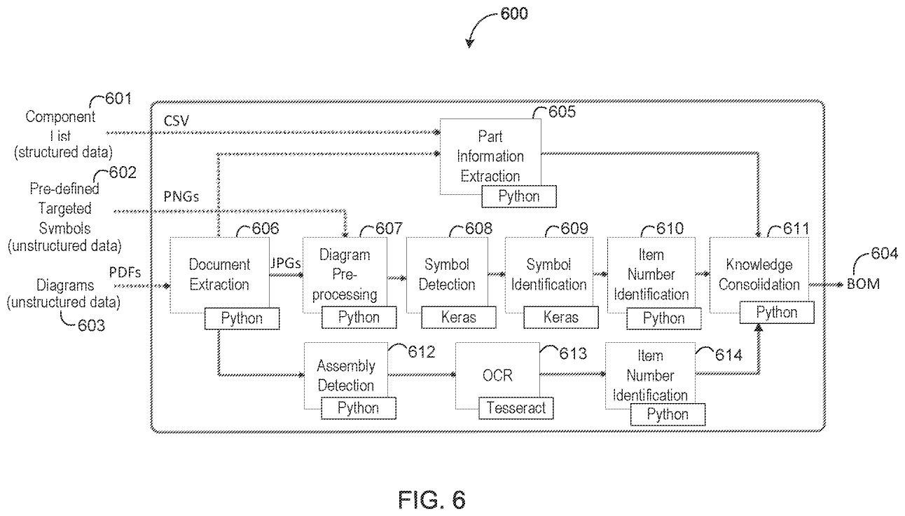

The architecture 300 supports heterogeneous execution environments for different steps in the DAG machine learning pipeline in order to allow a user the flexibility of using open-source languages, frameworks, and libraries. Each step in the machine learning pipeline may contain a unique language, language version, framework and libraries, and executor. For example, FIG. 6 illustrates an example DAG machine learning pipeline 600 that can be authored by users of the system in the authoring layer 301 of the architecture 300 shown in FIG. 3 according to this disclosure. As shown in FIG. 6, the DAG machine learning pipeline 600 is a computer vision pipeline that can be used for diagram parsing. The DAG machine learning pipeline 600 includes multiple source nodes 601-603 that provide structured and unstructured data and one sink node 604 that serves at an output of the DAG machine learning pipeline 600.

The DAG machine learning pipeline 600 includes multiple steps 605-614 developed using multiple languages and frameworks, including PYTHON, KERAS, and TESSERACT. For example, part information extraction 605 can include extraction of part information from the component list 601 and the diagrams 603 (e.g., PDF diagrams), document extraction 606 can include identifying separate documents in the diagrams 603, diagram pre-processing 607 can include cleaning up and filtering the document data, symbol detection 608 can include detecting specific symbols in the diagrams 603, symbol identification 609 can include identifying the specific symbols in the diagrams 603, item number identification 610 can include identifying item numbers in the diagrams 603, knowledge consolidation 611 can include consolidating information obtained from the diagrams 603, assembly detection 612 can include detection of one or more assemblies in the extracted documents, OCR 613 can include optical character recognition of the extracted documents, and item number identification 614 can include identifying item numbers in the extracted documents. Of course, these steps, languages, and frameworks are merely examples, and other steps, languages and frameworks may be additionally or alternatively used.

Although FIG. 6 illustrates one example of a DAG machine learning pipeline 600 that can be authored by users of the system in the authoring layer 301 of the architecture 300, various changes may be made to FIG. 6. For example, the specific DAG machine learning pipeline 600 shown here is for illustration only. Other machine learning pipelines supporting directed acyclic graphs may be used without departing from the scope of this disclosure.

Although FIG. 3 illustrates one example of an architecture 300 for machine learning pipeline generation and management, various changes may be made to FIG. 3. For example, the architecture 300 shown here is for illustration only. In general, ML pipeline architectures come in a wide variety of configurations, and FIG. 3 does not limit this disclosure to any particular ML pipeline architectures. Other ML pipeline architectures may be used without departing from the scope of this disclosure.

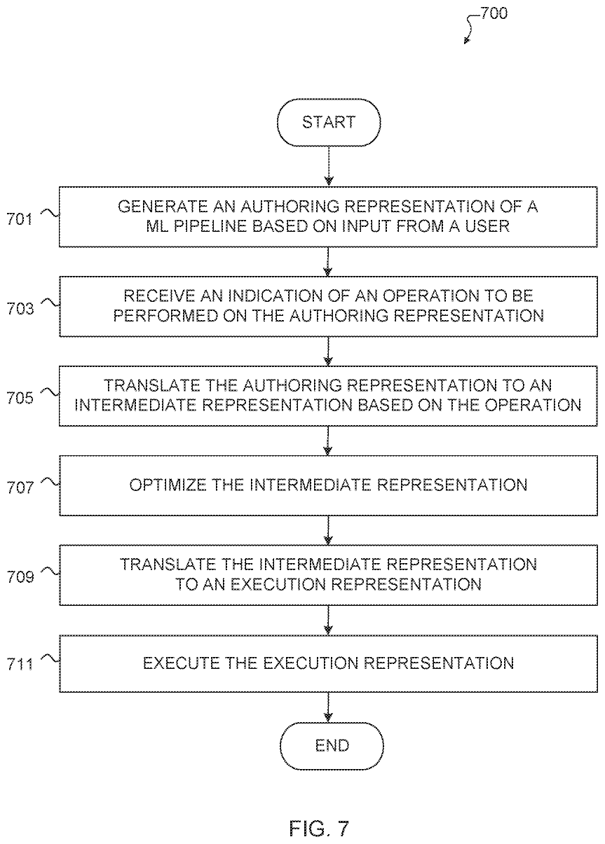

FIG. 7 illustrates an example method 700 for machine learning pipeline generation and management according to this disclosure. For ease of explanation, the method 700 shown in FIG. 7 is described as involving the use of the application server 106 shown in FIG. 1 and the architecture 300 shown in FIG. 3. However, the method 700 shown in FIG. 7 could be used with any other suitable device(s) and architecture(s) and in any other suitable system(s).

As shown in FIG. 7, an authoring representation of a machine learning pipeline is generated based on input from a user at step 701. This could include, for example, the server 106 generating an authoring representation 304 of a machine learning pipeline 308 using the authoring layer 301. In some embodiments, the authoring representation is configured to manage one or more machine learning operations without requiring machine learning operation-specific steps or different user-defined pipeline architectures corresponding to each machine learning operation.

An indication of an operation to be performed on the authoring representation is received from the user at step 703. This could include, for example, the server 106 receiving an indication of an operation 310 from the user. The authoring representation is translated to an intermediate representation based on the operation at step 705. This could include, for example, the server 106 performing the translation operation 305 to translate the authoring representation 304 to the intermediate representation 306. The intermediate representation is optimized at step 707. This could include, for example, the server 106 optimizing the intermediate representation 306 in the optimization layer 302. The intermediate representation is translated to an execution representation that is understood by one or more machine learning executors at step 709. This could include, for example, the server 106 translating the intermediate representation 306 to the execution representation 307 in the execution layer 303. The execution representation is executed at step 711. This could include, for example, the server 106 executing an application or code represented by the execution representation 307.

Although FIG. 7 illustrates one example of a method 700 for machine learning pipeline generation and management, various changes may be made to FIG. 7. For example, while shown as a series of steps, various steps in FIG. 7 could overlap, occur in parallel, occur in a different order, or occur any number of times.

In some embodiments, a method includes translating an intermediate representation to an execution representation that is understood by one or more machine learning executors, wherein the intermediate representation is an operation based translation of an authoring representation, wherein the authoring representation is of a machine learning pipeline configuration to manage one or more machine learning operations.

In some embodiments, various functions described in this patent document are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive (HDD), a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable storage device.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C. A and B, A and C, B and C. and A and B and C.

The description in the present application should not be read as implying that any particular element, step, or function is an essential or critical element that must be included in the claim scope. The scope of patented subject matter is defined only by the allowed claims. Moreover, none of the claims invokes 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module.” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method comprising:
generating an authoring representation of a machine learning pipeline based on a received input, the authoring representation configured to manage one or more machine learning operations;
receiving an indication of an operation to be performed on the authoring representation;
translating the authoring representation to an intermediate representation based on the operation;
optimizing the intermediate representation; and
translating the intermediate representation to an execution representation that is understood by one or more machine learning executors.

2. The method of claim 1, wherein the operation comprises at least one of:
training one or more machine learning operations,
tuning one or more training parameters of the one or more machine learning operations, predicting new data,
scoring a performance of a prediction result, and
interpreting a contribution level of different input data to prediction results.

3. The method of claim 2, wherein the operation comprises scoring the performance of the prediction result by scoring at least one of accuracy, precision, recall, and mean absolute error.

4. The method of claim 1, wherein optimizing the intermediate representation comprises combining multiple vertices of the intermediate representation with compatible execution environments into a single vertex for execution.

5. The method of claim 1, wherein optimizing the intermediate representation comprises dividing a single vertex into multiple vertices for concurrent execution.

6. The method of claim 1, further comprising:
dividing the execution representation into multiple parts for execution on different hardware.

7. The method of claim 1, wherein the machine learning pipeline comprises a previously-generated machine learning pipeline to which one or more pre-processing or post-processing operations have been subsequently added for a specific application.

8. The method of claim 1, further comprising:
composing multiple machine learning operations into a directed acyclic graph (DAG) machine learning pipeline.

9. The method of claim 1, wherein the authoring representation is configured to manage the one or more machine learning operations independent of machine learning operation-specific steps corresponding to each machine learning operation.

10. An apparatus comprising:
at least one processing device configured to:
generate an authoring representation of a machine learning pipeline based on a received input, the authoring representation configured to manage one or more machine learning operations;
receive an indication of an operation to be performed on the authoring representation;
translate the authoring representation to an intermediate representation based on the operation;
optimize the intermediate representation; and
translate the intermediate representation to an execution representation that is understood by one or more machine learning executors.

11. The apparatus of claim 10, wherein the operation comprises at least one of:
training one or more machine learning operations,
tuning one or more training parameters of the one or more machine learning operations, predicting new data,
scoring a performance of a prediction result, and
interpreting a contribution level of different input data to prediction results.

12. The apparatus of claim 11, wherein the operation comprises scoring the performance of the prediction result by scoring at least one of accuracy, precision, recall, and mean absolute error.

13. The apparatus of claim 10, wherein, to optimize the intermediate representation, the at least one processing device is configured to combine multiple vertices of the intermediate representation with compatible execution environments into a single vertex for execution.

14. The apparatus of claim 10, wherein, to optimize the intermediate representation, the at least one processing device is configured to divide a single vertex into multiple vertices for concurrent execution.

15. The apparatus of claim 10, wherein the at least one processing device is further configured to divide the execution representation into multiple parts for execution of the parts on different hardware.

16. The apparatus of claim 10, wherein the machine learning pipeline comprises a previously-generated machine learning pipeline to which one or more pre-processing or post-processing operations have been subsequently added for a specific application.

17. The apparatus of claim 10, wherein the at least one processing device is further configured to compose multiple machine learning operations into a directed acyclic graph (DAG) machine learning pipeline.

18. The apparatus of claim 10, wherein the authoring representation is configured to manage the one or more machine learning operations independent of machine learning operation-specific steps corresponding to each machine learning operation.

19. A non-transitory computer readable medium storing computer readable program code that when executed causes one or more processors to:
generate an authoring representation of a machine learning pipeline based on a received input, the authoring representation configured to manage one or more machine learning operations;
receive an indication of an operation to be performed on the authoring representation;
translate the authoring representation to an intermediate representation based on the operation;
optimize the intermediate representation; and
translate the intermediate representation to an execution representation that is understood by one or more machine learning executors.

20. The non-transitory computer readable medium of claim 19, wherein the operation comprises at least one of:
training one or more machine learning operations,
tuning one or more training parameters of the one or more machine learning operations, predicting new data,
scoring a performance of a prediction result, and
interpreting a contribution level of different input data to prediction results.
